(19) United States
(12) Patent Application Publication
(10) Pub. No.: US 2008/0075432 A1
(43) Pub. Date: Mar. 27, 2008

(54) Method and apparatus for connecting portable audio player to larger audio system

(76) Inventor: Joseph Cilluffo, Torrance, CA (US)

Correspondence Address: MURAMATSU & ASSOCIATES, Suite 310, 114 Pacifica, Irvine, CA, 92618, US

(21) Appl. No.: 11/525,148

(22) Filed: Sep. 21, 2006

(51) Int. Cl. H04N 7/00

(52) U.S. Cl. 386/96

(57) ABSTRACT

The method and apparatus for connecting a portable player to an external audio/video player having a larger display screen through an interface controller to operate the portable player so that the sound is reproduced by the external audio/video player and the music information is displayed on the larger display screen. The audio signals of the selected music can be sent wirelessly through FM transmission or wired transmission through physical cables connected to auxiliary inputs of the external audio/video player. The interface controller has a circuitry to detect the data format and structure used in the portable player and retrieves the text data from the portable player and generates a video signal to display the music information on the larger display screen.

### FIELD OF THE INVENTION

This invention relates generally to a method and apparatus for connecting a portable player to another audio/video system, and more particularly, to a method and apparatus for connecting a portable music player to an external audio/video player having a larger display screen through an interface controller to operate the portable player by the interface controller so that the sound is reproduced by the external music player and the music information is displayed on the larger display screen of the external music player.

### BACKGROUND OF THE INVENTION

Digital audio files, such as MP3, ATRAC (adaptive transform acoustic coding), WMA (windows media audio), AAC (advanced audio coding), etc are popular media for listening to music. Digital audio files are generally stored in a hard disk, CD-ROM, memory card, etc. They have the advantage that the files can be smaller than a conventional audio format used in a compact disk. They generally contain a tag-data (meta-data) that describes such information as, artist name, title of a song, genre of music, etc. Such information is often used by a digital audio player to display music information to help a user to select and identify the music.

Portable digital audio players, such as iPod (Apple, Inc.), are popular partly due to the amount of music they can hold and their portability. There is a demand to play music files in a portable digital audio player (hereafter “portable player”) by such an audio player in an automobile (vehicle) audio system or an audio player at home. This is because when a user has already corrected a pile of audio files in the portable player, the user wants to reproduce the music pieces in the portable player by an audio player in a vehicle or in the user's bedroom, etc.

FIG. 1 is a schematic diagram showing an example where a portable player is connected to an automobile audio/video system to play the music on the speakers of the automobile audio system. A portable player 10 is connected to an automobile audio system 39 though a link unit 20. The automobile audio system 39 has a receptacle that receives music signals from the portable player 10 to which one end of the link unit 10 is connected.

Thus, the user is able to listen to music on the automobile audio system 39 without wearing earphones while driving the automobile. However, the user have to look at a small screen 16 on the portable player 10 to see information about the music titles and artist's names, etc. Moreover, an operation must be done by using a small controller 13, for example, to skip a music or fast forward a music. Thus, when driving, it is not only cumbersome but also dangerous to use the portable player 10.

Therefore, there is a need that the user is able to operate a portable player through an automobile audio player easily and safely. More particularly, there is a need of a new system that allows the user to see the same music information on the portable player on a larger screen for improved visibility and means for operating the portable player by an interface controller without using the small controller attached to the portable player.

### SUMMARY OF THE INVENTION

It is, therefore, an object of the present invention to provide a method and apparatus for connecting a portable player with an external audio/video player having a larger display screen through an interface controller to operate the portable player by the interface controller so that the sound is reproduced by the external player and the music information is displayed on the larger display screen of the external player.

One aspect of the present invention is a method for operating a portable player by connecting the portable player with an external audio/video player. The method includes the steps of connecting a video signal line between one end of an interface controller and the external audio/video system, connecting the portable player with another end of the interface controller, retrieving output data from the portable player where the output data include audio signals for reproducing audible sounds and text data for describing music information, sending the audio signals to the external audio/video system for reproducing the audible sounds of a selected music by the external audio/video system, converting the text data extracted from the output data to video signals, sending the video signals to the external audio/video system through the video signal line and displaying the music information on a monitor screen of the external audio/video system, and controlling an operation of the portable player by sending a command signal to the portable player through the interface controller.

In the present invention, the process of sending the audio signals to the external audio/video system includes a process of transmitting the audio signals to the external audio/video system through an audio signal line. Alternatively, the process of sending the audio signals to the external audio/video system includes a process of modulating the audio signals to create FM (frequency modulated) signals and transmitting the FM signals wirelessly to the external audio/video system.

The method of the present invention further performs a process of detecting a data format and a data structure of the output data from the portable player when specifications of the portable player are unknown. The process of detecting the data format and structure of the output data of the portable player includes a process of extracting the text data from the output data from the portable player after determining the data format and structure.

In the method of the present invntion, the music information displayed on the monitor screen of the external audio/video system is the same or similar to that displayed on a display screen of the portable player. The process of controlling the operation of the portable player includes a process of selecting a music from a list of music titles displayed on the monitor screen of the external audio/video system. The process of controlling the operation of the portable player includes a process of operating a remote controller or a set of control keys formed on the interface controller to send the command signal to the portable player.

Another aspect of the present invention is an apparatus for connecting the portable player with the external audio/video player having a monitor screen which is much larger than a display screen of the portable player. The apparatus of the present invention is configured by components corresponding to the various steps defined in the method noted above to implement the steps.

According to the present invention, the portable player can be connected with the external audio/video player having a larger display screen through the interface controller to operate the portable player by the interface controller so that the sound is reproduced by the external audio/video player and the music information is displayed on the larger display screen of the external audio/video player. In the case where the external audio/video player is a head unit of an automobile audio/video system, the safe driving and ease of operation can be attained since the driver does not have to use the small display screen and small controller for operating the portable player.

The interface controller has a circuitry to detect the data format and structure used in the portable player and retrieves the text data from the portable player and generates a video signal to display the music information on the larger display screen. Thus, even when the specification of the portable player is unknown, it is possible to retrieve the music information from the portable player and display the retrieved music information on the larger display screen.

### BRIEF DESCRIPTION OF THE DRAWINGS

FIG. 1 is a schematic diagram showing an example of using a portable player in an automobile where a portable player is connected to an automobile audio/video system through a link unit to play the music by speakers of the automobile audio/video system.

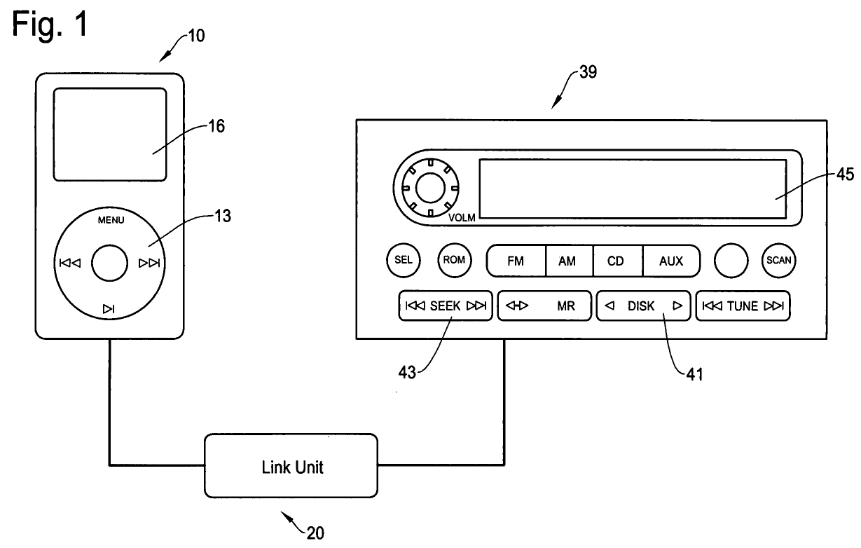

FIG. 2 is a schematic diagram showing an example of structure of the apparatus of the present invention where an interface controller is used to connect the portable player with an automobile audio/video system and to control the portable player through the interface controller.

FIG. 3 is a schematic view showing another example implementation of the present invention where the automobile audio/video system has the functionality of the interface controller.

FIG. 4 is a block diagram showing an example of structure of an overall system under the present invention for reproducing audio files by connecting a portable player and an automobile audio/video system.

FIGS. 5A-5B show display examples on a monitor screen of the automobile audio/video system to display the music information which is the same or similar to that shown on the portable player.

FIG. 6 is a flow chart describing an example of the basic steps of operation of the method and apparatus of the present invention for displaying the music information on the larger screen and controlling the portable player.

FIG. 7 is a schematic block diagram showing an example of structure of the communication section used in the interface controller of the present invention shown in FIG. 4.

FIG. 8 is a schematic block diagram showing an example of structure of the video signal generator used in the interface controller of the present invention shown in FIG. 4.

### DETAILED DESCRIPTION OF THE PREFERRED EMBODIMENT

The present invention will be described in detail with reference to the accompanying drawings. The method and apparatus of the present invention is designed to allow a portable player to be connected to an external audio/video system having a monitor screen which is much larger than a screen of the portable player. Typically, such a large screen is a head unit of an automobile audio/video system or a specially prepared display such as a liquid crystal display (LCD) unit for the purpose of the present invention. It should be noted that although the present invention is described with respect to the case where it is implemented for an automobile audio/video system, the present invention is not limited to such a specific application. For example, the present invention can be implemented for connecting a portable player with a home audio/video system, etc.

The method and apparatus of the present invention displays music information on the larger screen of the head unit, controls the portable player through an interface controller, and outputs audio files to the head unit so that music can be heard in a vehicle through the automobile audio/video system. The method and apparatus of the present invention retrieve the music information (music title, artist's name, album title, etc.) from the portable player and decode the music information. The method and apparatus convert the decoded music information to a video signal by, for example, a video signal generator in the interface controller, to display the music information on the monitor screen of the head unit.

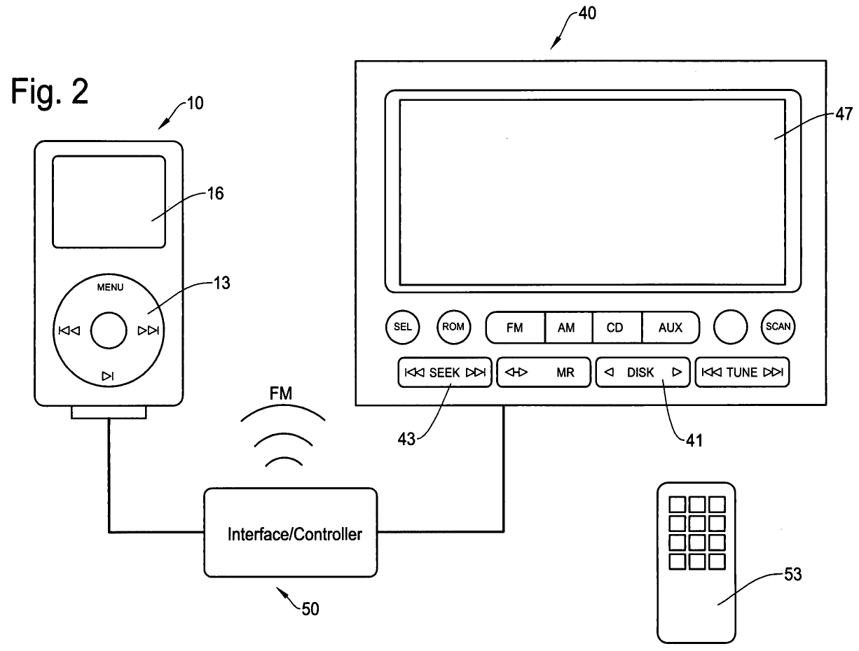

FIG. 2 is a schematic diagram showing a basic implementation of the present invention where an interface controller 50 is used to connect the portable player 10 to a head unit 40 of the automobile audio/video system. The portable player 10, such as iPod, etc., has its own display 16 and a controller 13. The display 16 of the portable player 10 generally displays such information as music titles, album titles, and artist's names. The user is able to operate the portable player 10 by manipulating the controller 13. For instance, the user may skip, forward or backward one or more songs.

The portable player 10 generally has a communication port that has the capacity of communicating with an outside device, typically a personal computer. In FIG. 2, one end of the interface controller 50 is connected to the portable player 10 through the communication port. The other end of the interface controller 50 is connected to the head unit 40 of the automobile audio/video system.

The head unit 40 has a monitor screen 47, and several operation buttons, such as a seek button 43 and a disk button 41. Other buttons may also be provided for operating the head unit 40. A remote controller 53 controls the operation of the portable player 10 through the interface controller 50, and can be used to skip, find a particular song, or stop a song, etc. As noted above, instead of the monitor screen 47 provided in the automobile, a separate display such as a liquid crystal display (LCD) unit can also be used for the purpose of the present invention.

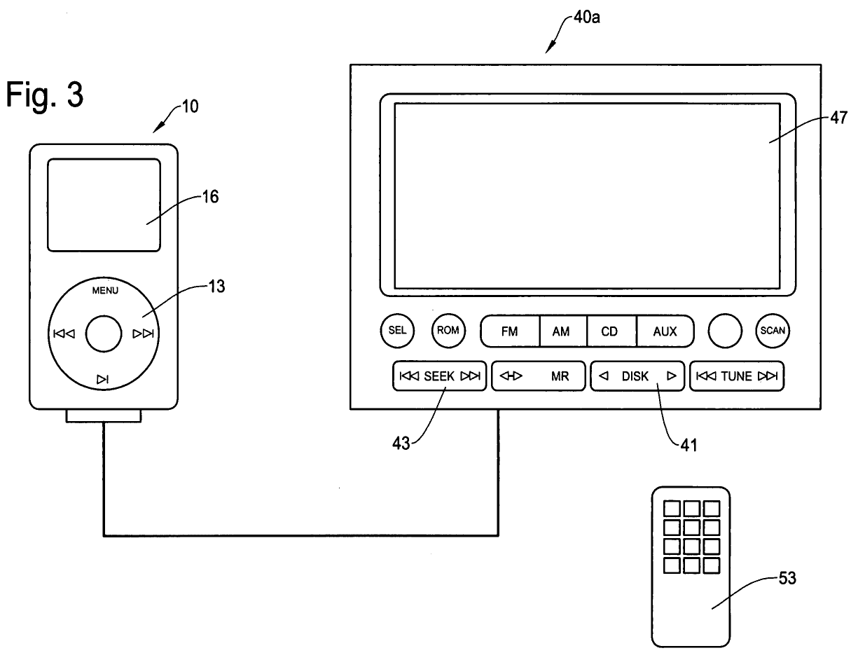

FIG. 3 is a schematic diagram showing another example of implementation of the present invention where a head unit 40a installs the functionality of the interface controller 50 shown in FIG. 2. In contrast to the configuration shown in FIG. 2, the configuration in FIG. 3 allows direct connection between the portable player 10 and the head unit 40a. The remote controller 53 performs the same function as that of FIG. 2.

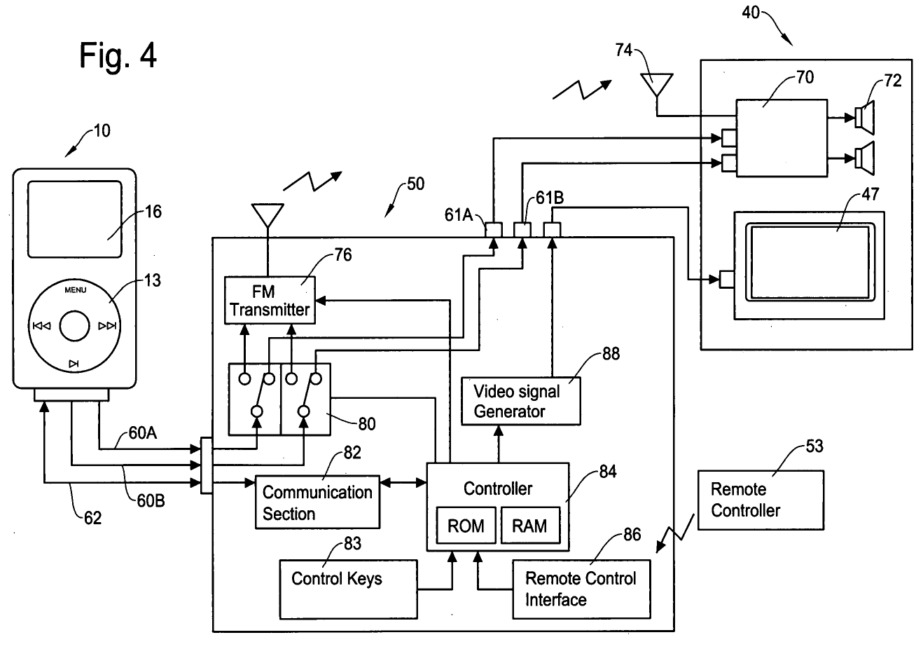

FIG. 4 is a block diagram showing an example of structure of the interface controller 50 of the present invention to connect the portable player 10 to the head unit 40 of the automobile audio/video system. As noted above, the portable player 10 has the display screen 16 and the controller 13 which can be used even when connected to the head unit 40. However, instead of using such small a display screen 16 and a controller 13 on the portable player 10, the present invention allows the user to use the monitor screen 47 of the head unit 40 and the remote controller 53 to operate the portable player 10. In this application, the monitor screen 47 of the head unit 40 may be set to an auxiliary input mode to receive the video signals from the interface controller 50 to display the music information from the portable player 10.

In this example, the interface controller 50 is comprised of an FM transmitter 76, a switch unit 80, a communication section 82, a controller (processor) 84, a video signal generator (character generator) 88, a remote control interface 86, and the remote controller 53. The lines connecting the portable player 10 and the interface controller 50 are comprised of one or more data lines 62, one or more right channel signal lines 60A and one or more left channel signal lines 60B although additional lines may also be used.

The switch unit 80 is used to switch between the FM transmitter 76 and physical lines for transmitting audio signals to the head unit 40. The user may select either one of the transmission methods. In FIG. 4, the switch unit 80 is in a condition to connect the music signals from the right and left channel signal lines 60A and 60B to the physical lines through right and left channel output lines 61A and 61B. When the switch unit 80 is latched to the other side, the audio signals from the right and left channel signal lines 60A-60B are transmitted to the FM transmitter 76.

The FM transmitter 76 functions to modulate the audio signals received from the portable player 10 to produce FM (frequency modulated) signals. The FM transmitter 76 wirelessly transmits the FM signals so that an FM receiver of an audio section 70 of the head unit 40 or other FM radio receiver can receive the FM signals through an antenna 74. This is done by setting a radio tuner of the audio section 70 to a specified FM frequency that matches the carrier frequency of the FM signals produced by the FM transmitter 76. The speakers 72 of the head unit 40 or other automobile audio/video system reproduces sounds of the selected music, etc., based on the received FM signals.

In FIG. 4, the FM receiver receives the FM signals emitted by the FM transmitter 76 through the antenna 74, and the audio section 70 will convert (demodulate) the FM signals to the audio signals so that sounds will be produced by the speakers 72. Thus, when the user listens to the music from the portable player 10 wirelessly by using the FM signals, the user changes the head unit setting to an FM radio mode and adjusts the frequency to the that of the FM signals from the FM transmitter. Alternatively, the user can listen to the music by setting the head unit 40 to an external audio input mode and connecting the output lines 61A and 61B to the audio section 70 to receive the audio signals from the portable player 10.

The communication section 82 is capable of receiving the data such as music information from the portable player 10 and sending instruction signals to the portable player 10. The communication section 82 has a decoder that decodes the data from the portable player 10 which is typically text data indicating the music information shown on the display 16 of the portable player 10. The decoded data is sent to the video signal generator 88 through the controller 84 where the decoded data is converted to video signals.

The video signal generator 88 sends the video signals to the head unit 40 through video signal lines which are connected to external video signal input terminals of the head unit 40. Thus, the head unit 40 is able to show the music information on the monitor screen 47 which is basically same or similar to the music information shown on the display 16 of the portable player 10. In the case where the head unit 40 does not have such external video signal inputs, a separate display such as an LCD may be used. The controller 84 functions to control the overall operation of the interface controller 50.

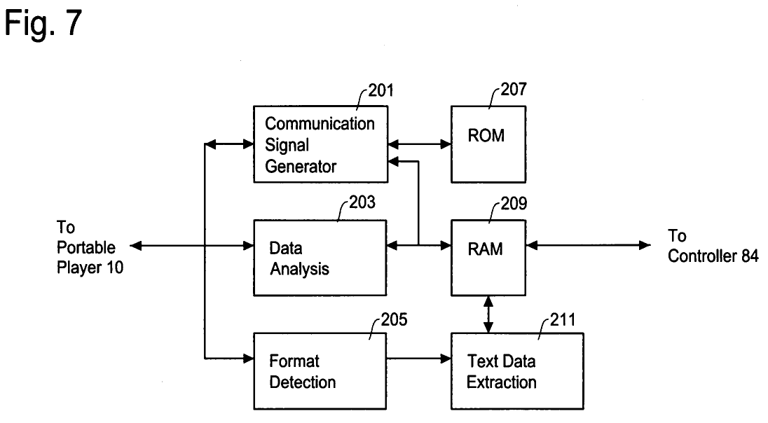

An example of detailed structure of the communication section 82 is described with reference to the block diagram of FIG. 7. In this example, the communication section 82 is designed to detect text data used in the portable player 10 even if the format or other specification of the data from the portable player 10 is unknown. Thus, in the case where the interface controller 50 is used only for a portable player whose specification of the data is known because of, for example, license agreement, the communication section 80 can be greatly simplified since it is unnecessary to analyze the data or detect a format of the data, etc.

In FIG. 7, the communication section 82 is comprised of a communication signal generator 201, a data analysis unit 203, a format detection unit 205, a ROM 207, a RAM 209, and a text data extraction unit 211. The communication signal generator 201 generates instruction signals to communicate with the portable player 10. For example, the communication signal generator 201 generates signals to instruct the portable player 10 to change the music information on the display, select a music title from the list on the display, start playing the music, etc. The data necessary for communication, such as a set of commands, may be stored in the ROM 207.

The format detection unit 205 detects a type of data format used in the data from the portable player 10. For example, it may detect whether the data used in the portable player 10 is in an MP3 format or a WMA format, etc., by applying various formats to the output data from the portable player 10. When the format detection unit 205 detects the format of the output data from the portable player 10, it is possible to retrieved the text data, control signals, etc. from the portable player 10.

The data analysis unit 203 is used to analyze the data of the portable player 10. The data analysis unit 203 may analyze such data as the data structure, folder structure, etc., used in the portable player 10. Since the data format is known because the format detection unit 205 now detects the data format of the unknown portable player 10, the data analysis unit 203 can conduct such analysis correctly.

Typically, music files often have associated tag data, such as a name of the artist, genre, title of the music piece, title of album, etc. The text data extraction unit 211 can extract such data as well as the name of the music file as text data. The extracted text data are temporarily stored in the RAM 209 and are also transmitted to the controller 84 for displaying them on the monitor screen 47 of the head unit 40. Thus, the interface controller 50 is able to produce the music information image on the head unit 40 which is the same or similar to the music information displayed on the portable player 10 and controls the operation of the portable player 10 through the remote controller 53.

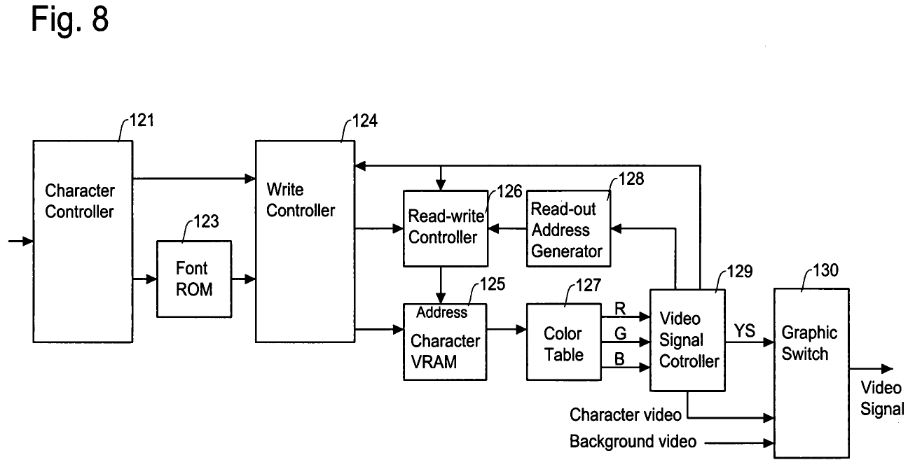

An example of structure in the video signal generator 88 for producing the video signal for the music information is described with reference to a block diagram of FIG. 8. In this example, the video signal generator (character generator) 88 receives the text data from the portable player 10 through the controller 84 and converts the text data to the video signals to display characters (music information) on the monitor screen 47 of the head unit 40. As shown, the video signal generator 88 is comprised of a character controller 121, a font ROM 123, a write controller 124, a character VRAM 125, a read-write controller 126, a color table 127, a read-out address generator 128, and a video signal controller 129.

Based on the data from the controller 84, the characters to be displayed and the display position are specified to the character controller 121. The character controller 121 generates an address to read font data of the specified character and outputs the address data to the font ROM 123. The character controller 111 generates X, Y coordinates for a display and outputs the coordinates to the write controller 124. The data from the font ROM 113 and the X, Y coordinates are input to the write controller 124. The X, Y coordinates are converted to the address of the character VRAM 115.

The address of the character VRAM 125 is sent to the read-write controller 126. The read-write controller 126 sends the data of the write controller 114 into the character VRAM 125. When data is to be written to the character VRAM 125, the output address of the write controller 124 is selected. When the display data is to be read out, the output from the read-out address generator 128 becomes the address of the character VRAM 115. The character read out from the character VRAM 115 can be a table number for the color table 127 to specify the color of the character.

The color data (R, G, B) is input to the video signal controller 129 and is converted to a video signal. The video signal controller 129 provides an operation timing signal to the read-out address generator 128 and the read-write controller 126. The output signal from the video signal controller 129 and the back ground video signal are input to the graphic switch 130, and are switched by the superimpose signal YS from the video signal controller 129. As a result, the text from the portable player 10 is displayed on the monitor screen 47 of the head unit 40. The details of the video signal generator are disclosed, for example, by Japanese patent laid-open publication No. 8-95553, which is hereby incorporated by reference.

Referring back to FIG. 4, the remote controller 53 is used to operate the portable player 10 via the interface controller 50. The signals from the remote controller 53 are transmitted to the remote control interface 86. The controller 84 is able to provide appropriate instructions to the relevant components depending on the signals received from the remote control interface 86. In this embodiment, the remote controller 53 communicates directly with the interface controller 50. However, it is also feasible to control the portable player 10 by establishing a set of control keys 83 on the interface controller 50 as shown in FIG. 4.

An example of specific operation of the method and apparatus of the present invention using the interface controller 50 as a major component is now described. As the user connects the portable player 10 to the interface controller 50 and also connects the interface controller 50 to the head unit 40 through video signal lines, electric connection has been established. The communication section 82 sends signals to the portable player 10 to instruct the portable player 10 to output the music information.

As noted above, the communication section 82 has the decoder that decodes the signals from the portable player 10. Thus, the text data indicating the music information such as artist's names and song titles are acquired. The text data will be converted to the video signals by the video signal generator 88 so that the music information can be displayed on the monitor screen 47 of the head unit 40. Thus, the music information which is the same or similar to that shown on the screen 16 of the portable player 10 can also be displayed on the monitor screen 47 of the head unit 40 which is much larger than the screen 16.

In response to the user's command through the remote controller 53, the controller 84 instructs the communication section 82 to send command signals to the portable player 10 to perform the requested operations. As the new command is performed by the portable player 10, the display of the head unit 40 reflects the change as necessary. The audio signal is transmitted from the portable player 10 via the right channel signal line 60A and the left channel signal line 60B. Depending on the setting of the switch unit 80, the audio signal may be transmitted either to the outputs 61A-61B for wired transmission or to the FM transmitter 76 for wireless transmission.

In communicating with the portable player 10, the interface controller 50 may have a predefined command set to communicate with a particular portable player whose specification is known. In such a case, the communication can be performed without difficulty since the necessary data for communicating to the portable music is available. The data for communication may be pre-stored in the device at shipment from the manufacturer, or such data may be updated through, for example, CD-ROM or internet connection to accommodate new models and various available music devices.

In the case where the data for communication for a particular portable player is not known, the interface controller 50 may attempt to analyze the data from the portable player 10. As noted above, the interface controller 50 detects the data format and data structure used in the portable player 10 to retrieve music information and audio signals from the portable player 10 and control the operation of the portable player 10. Such an operation for detecting the data format and structure can be done by the format detection unit 205, data analysis unit 203, etc., in the communication section 82 shown in FIG. 7.

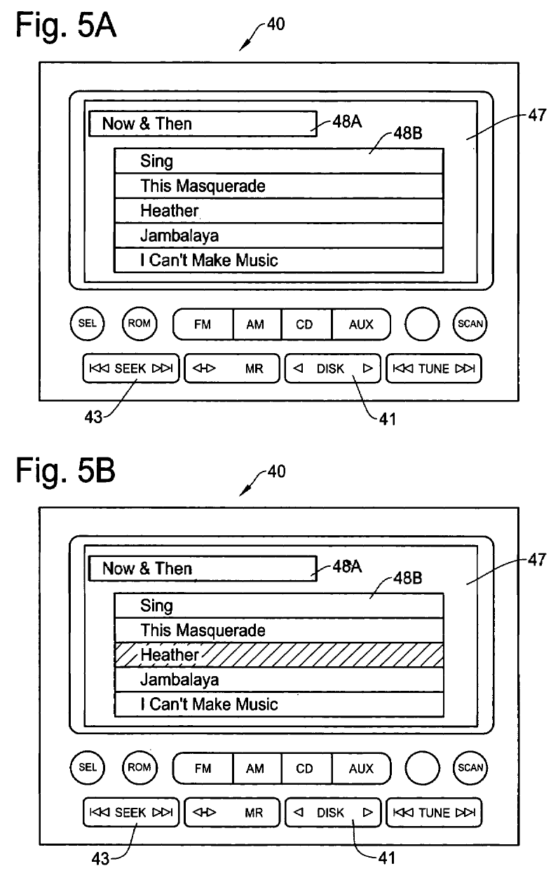

FIG. 5A is a display example on the monitor screen 47 of the head unit 40 that will be displayed as result of connecting the portable player 10 to the head unit 40. The monitor screen 47 lists the name of songs and title of the album. In this case, the album title 48A indicates that the title of the album is “Now & Then” and the listed music in the album are “Sing”, “This Masquerade”, “Heather”, “Jambalaya”, and “I Can't Make Music”. Since the monitor screen 47 of the head unit 40 is much larger than that of the portable player 10, the user is able to see the information of the songs more easily and clearly.

Although only music titles are listed on the monitor screen 47, other information such as the length of the song or album titles may be listed as well. By using the remote controller 53, the user is able to perform various operations, such as skipping a song, selecting a song, or stopping a song, etc. Although the above example arranges the songs based on the album title, other arrangement is also possible. For example, the songs may be arranged according to genre or an alphabetical order.

FIG. 5B is a display example on the monitor screen 47 similar to that shown in FIG. 5A except that the song “Heather” has been selected (highlighted). Typically, the remote controller 53 has a set of arrow keys that allows the highlight to move along the list to select one of the songs. Alternatively, the remote controller 53 may have numeric keys to select a particular song from the list.

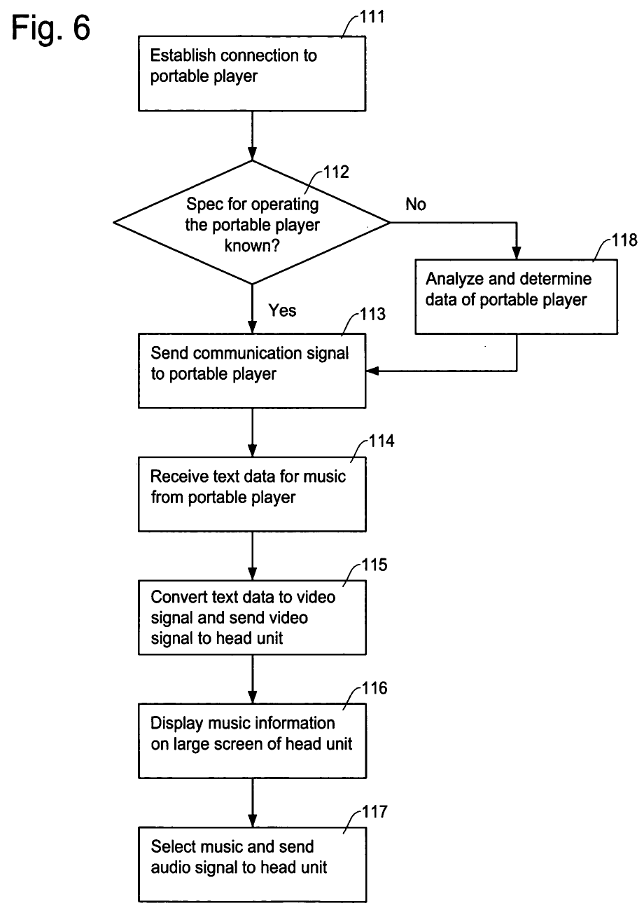

FIG. 6 is a flow chart showing an example of basic operation of the present invention for displaying the music information from the portable player on the head unit and controlling the operation of the portable player through the interface controller 50. In the first step 111, the interface controller 50 determines if a portable player 10 has been connected. When the portable player 10 has been connected, in the step 112, the interface controller 50 will determine if the specification of the portable player 10 is known and thus the interface controller 50 already has necessary data to operate the portable music player.

If the specification of the portable player 10 is known, the interface controller 50 sends a communication signal to determine the status of the portable player 10 in the step 113. If the specification of the portable player 10 is not known, thus the interface controller 50 does not have the data for operating the portable player 10, the interface controller 50 will analyze the portable player 10 to determine the data format and structure, etc., of the portable player 10 in the step 118. In the case where this process fails, the operation stops.

If the interface controller 50 successfully determines the data format and structure of the portable player 10, the process moves to the step 113 where the interface controller 50 sends the communication signal to the portable player. In the step 114, the interface controller 50 receives music information including the text data indicating music titles and artist's names, etc., from the portable player 10.

Based on the text data, the interface controller 50 converts the text data to the video signal and sends the video signal to the head unit 40 in the step 115. As a result, the monitor screen 47 of the head unit 40 displays the music information as shown in FIGS. 5A and 5B in the step 116. The user selects one or more songs from the list displayed on the monitor screen 47 of the head unit 40 in the step 117 so that the portable player 10 starts playing the selected songs. As noted above, the audio signals from the portable player 10 are sent to the head unit 40 through the wire connection or through the FM transmission.

As has been described above, according to the present invention, the portable player can be connected with the external audio/video player having a larger display screen through the interface controller to operate the portable player by the interface controller so that the sound is reproduced by the external audio/video player and the music information is displayed on the larger display screen of the external audio/video player. In the case where the external audio/video player is a head unit of an automobile audio/video system, the safe driving and ease of operation can be attained since the driver does not have to use the small display screen and small controller for operating the portable player.

The interface controller has a circuitry to detect the data format and structure used in the portable player and retrieves the text data from the portable player and generates a video signal to display the music information on the larger display screen. Thus, even when the specification of the portable player is unknown, it is possible to retrieve the music information from the portable player and display the retrieved music information on the larger display screen.

Although the invention is described herein with reference to the preferred embodiment, one skilled in the art will readily appreciate that various modifications and variations may be made without departing from the spirit and scope of the present invention. Such modifications and variations are considered to be within the purview and scope of the appended claims and their equivalents.

What is claimed is:

1. A method of operating a portable player by connecting the portable player with an external audio/video system, comprising the following steps of:
connecting a video signal line between one end of an interface controller and the external audio/video system;
connecting the portable player with another end of the interface controller;
retrieving output data from the portable player where the output data include audio signals for reproducing audible sounds and text data for describing music information;
sending the audio signals to the external audio/video system for reproducing the audible sounds of a selected music by the external audio/video system;
converting the text data extracted from the output data to video signals;
sending the video signals to the external audio/video system through the video signal line and displaying the music information on a monitor screen of the external audio/video system; and
controlling an operation of the portable player by sending a command signal to the portable player through the interface controller.

2. A method of operating a portable player as defined in claim 1, wherein said step of sending the audio signals to the external audio/video system includes a step of transmitting the audio signals to the external audio/video system through an audio signal line.

3. A method of operating a portable player as defined in claim 1, wherein said step of sending the audio signals to the external audio/video system includes a step of modulating the audio signals to create FM (frequency modulated) signals and transmitting the FM signals wirelessly to the external audio/video system.

4. A method of operating a portable player as defined in claim 1, further comprising a step of detecting a data format and a data structure of the output data from the portable player when specifications of the portable player are unknown.

5. A method of operating a portable player as defined in claim 4, wherein said step of detecting the data format and structure of the output data of the portable player includes a step of extracting the text data from the output data from the portable player after determining the data format and structure.

6. A method of operating a portable player as defined in claim 1, wherein said step of converting the text data to the video signals includes a step of retrieving characters from a character memory based on the text data.

7. A method of operating a portable player as defined in claim 1, wherein said music information displayed on the monitor screen of the external audio/video system is the same or similar to that displayed on a display screen of the portable player.

8. A method of operating a portable player as defined in claim 1, wherein said step of controlling the operation of the portable player includes a step of selecting a music from a list of music titles displayed on the monitor screen of the external audio/video system.

9. A method of operating a portable player as defined in claim 1, wherein said step of controlling the operation of the portable player includes a step of operating a remote controller to send the command signal to the portable player through the interface controller.

10. A method of operating a portable player as defined in claim 1, wherein said step of controlling the operation of the portable player includes a step of operating a set of control keys formed on the interface controller to send the command signal to the portable player.

11. An apparatus of operating a portable player by connecting the portable player with an external audio/video system, comprising:
means for connecting a video signal line between one end of an interface controller and the external audio/video system;
means for connecting the portable player with another end of the interface controller;
means for retrieving output data from the portable player where the output data include audio signals for reproducing audible sounds and text data for describing music information;
means for sending the audio signals to the external audio/video system for reproducing the audible sounds of a selected music by the external audio/video system;
means for converting the text data extracted from the output data to video signals;
means for sending the video signals to the external audio/video system through the video signal line and for displaying the music information on a monitor screen of the external audio/video system; and
means for controlling an operation of the portable player by sending a command signal to the portable player through the interface controller.

12. An apparatus of operating a portable player as defined in claim 11, wherein said means for sending the audio signals to the external audio/video system includes means for transmitting the audio signals to the external audio/video system through an audio signal line.

13. An apparatus of operating a portable player as defined in claim 11, wherein said means for sending the audio signals to the external audio/video system includes means for modulating the audio signals to create FM (frequency modulated) signals and transmitting the FM signals wirelessly to the external audio/video system.

14. An apparatus of operating a portable player as defined in claim 11, further comprising means for detecting a data format and a data structure of the output data from the portable player when specifications of the portable player are unknown.

15. An apparatus of operating a portable player as defined in claim 14, wherein said means for detecting the data format and structure of the output data of the portable player includes means for extracting the text data from the output data from the portable player after determining the data format and structure.

16. An apparatus of operating a portable player as defined in claim 11, wherein said means for converting the text data to the video signals includes means for retrieving characters from a character memory based on the text data.

17. An apparatus of operating a portable player as defined in claim 11, wherein said music information displayed on the monitor screen of the external audio/video system is the same or similar to that displayed on a display screen of the portable player.

18. An apparatus operating a portable player as defined in claim 11, wherein said means for controlling the operation of the portable player includes means for selecting a music from a list of music titles displayed on the monitor screen of the external audio/video system.

19. An apparatus of operating a portable player as defined in claim 11, wherein said means for controlling the operation of the portable player includes means for operating a remote controller to send the command signal to the portable player through the interface controller.

20. An apparatus of operating a portable player as defined in claim 11, wherein said means for controlling the operation of the portable player includes means for operating a set of control keys formed on the interface controller to send the command signal to the portable player.
